(19) United States
(12) Patent Application Publication
(10) Pub. No.: US 2013/0059276 A1
(43) Pub. Date: Mar. 7, 2013

(54) SYSTEMS AND METHODS FOR LANGUAGE LEARNING

(71) Applicants: Mollie Allen, American Fork, UT (US); Susan Bartholomew, Payson, UT (US); Mary Halbostad, Pleasant Grove, UT (US); Xinchuan Zeng, Orem, UT (US); Leo Davis, Sandy, UT (US); Joseph Shepherd, Orem, UT (US); John Shepherd, Sandy, UT (US)

(72) Inventors: Mollie Allen, American Fork, UT (US); Susan Bartholomew, Payson, UT (US); Mary Halbostad, Pleasant Grove, UT (US); Xinchuan Zeng, Orem, UT (US); Leo Davis, Sandy, UT (US); Joseph Shepherd, Orem, UT (US); John Shepherd, Sandy, UT (US)

(73) Assignee: SPEECHFX, INC., Lindon, UT (US)

(21) Appl. No.: 13/224,197

(22) Filed: Sep. 1, 2011

(51) Int. Cl. G09B 19/04

(52) U.S. Cl. 434/167

(57) ABSTRACT

Exemplary embodiments are directed to language learning systems and methods. A method may include receiving an audio input including one or more phonemes. The method may also include generating an output including feedback information of a pronunciation of each phoneme of the one or more phonemes. Further, the method may include providing at least one graphical output associated with a proper pronunciation of a selected phoneme of the one or more phonemes.

### BACKGROUND

1. Field

The present invention relates generally to language learning. More specifically, the present invention relates to systems and methods for enhancing a language learning process by providing a user with an interactive and personalized learning tool.

2. Background

The business of teaching people to speak new languages is one that is expanding. Over time, various forms of tutorials and guides have developed to help people learn new languages. Many conventional approaches have either required the presence of teachers, along with many other students, or they have required students to self-teach themselves. The requirement of a cooperation of time between students and teachers in this may not be suitable for many individuals, and may be costly. Further, although written materials (e.g., textbooks or language workbooks) may allow a student to study by himself at his own pace, written materials cannot effectively provide the student with personalized feedback.

Various factors, such as globalization, have created new and more sophisticated language learning tools. For example, with the advancement of technology, electronic language learning systems, which enable a user to study in an interactive fashion, have recently become popular. As an example, computers have powerful multimedia functions that allow users, at their own pace, to not only learn a language through reading and writing, but also through sound, which may increase the user's listening skills and help with memorization.

However, conventional electronic language learning systems fail to provide adequate feedback (e.g., about a user's pronunciation) to enable the user to properly and efficiently learn a language. Further, conventional systems lack ability to practice or correct mistakes, or focus on specific areas, which need improvement and, therefore, the learning process may not be optimized.

A need exists for methods and systems for enhancing a language learning process. More specifically, a need exists for language learning systems, and associated methods, which provide a user with an interactive and personalized learning tool.

### BRIEF DESCRIPTION OF THE DRAWINGS

FIG. 1 is a block diagram illustrating a computer system, according to an exemplary embodiment of the present invention.

FIG. 2 is a block diagram of a language learning system, in accordance with an exemplary embodiment of the present invention.

FIG. 3 is a screen shot of a language learning application page including a plurality of selection buttons and a drop-down menu, according to an exemplary embodiment of the present invention.

FIG. 4 is another screen shot of a language learning application page, according to an exemplary embodiment of the present invention.

FIG. 5 is a screen shot of a language learning application page illustrating scores for a plurality of phonemes of a spoken word, according to an exemplary embodiment of the present invention.

FIG. 6 is a screen shot of a language learning application page illustrating a setting window for adjusting a threshold, in accordance with an exemplary embodiment of the present invention.

FIG. 7 is a screen shot of a language learning application page illustrating scores for a plurality of phonemes of a spoken sentence, according to an exemplary embodiment of the present invention.

FIG. 8 is a screen shot of a language learning application page illustrating scores for a plurality of phonemes of a spoken word, according to an exemplary embodiment of the present invention.

FIG. 9 is a screen shot of a language learning application page illustrating scores for a plurality of phonemes of a spoken sentence, according to an exemplary embodiment of the present invention.

FIG. 10 is a screen shot of a language learning application page illustrating a video recording, according to an exemplary embodiment of the present invention.

FIG. 11 is another screen shot of a language learning application page illustrating the video recording, according to an exemplary embodiment of the present invention.

FIG. 12 is a screen shot of a language learning application page illustrating a multi-step guide, according to an exemplary embodiment of the present invention.

FIG. 13 is another screen shot of a language learning application page illustrating the multi-step guide, according to an exemplary embodiment of the present invention.

FIG. 14 is another screen shot of a language learning application page illustrating the multi-step guide, according to an exemplary embodiment of the present invention.

FIG. 15 is another screen shot of a language learning application page illustrating the multi-step guide, according to an exemplary embodiment of the present invention.

FIG. 16 is another screen shot of a language learning application page illustrating multi-step guide, according to an exemplary embodiment of the present invention.

FIG. 17 is yet another screen shot of a language learning application page illustrating the multi-step guide, according to an exemplary embodiment of the present invention.

FIG. 18 is a screen shot of a language learning application page illustrating an animation function, according to an exemplary embodiment of the present invention.

FIG. 19 is another screen shot of a language learning application page illustrating the animation function, according to an exemplary embodiment of the present invention.

FIG. 20 is another screen shot of a language learning application page illustrating the animation function, according to an exemplary embodiment of the present invention.

FIG. 21 is yet another screen shot of a language learning application page illustrating the animation function, according to an exemplary embodiment of the present invention.

FIG. 22 is a screen shot of a language learning application page illustrating functionality with respect to a spoken sentence, according to an exemplary embodiment of the present invention.

FIG. 23 is a flowchart illustrating a method, in accordance with an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

Referring in general to the accompanying drawings, various embodiments of the present invention are illustrated to show the structure and methods for a computer network security system. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of the invention.

The following provides a more detailed description of the present invention and various representative embodiments thereof. In this description, functions may be shown in block diagram form in order not to obscure the present invention in unnecessary detail. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

In this description, some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

Exemplary embodiments, as described herein, are directed to systems and methods for enhancing a language learning process. Further, exemplary embodiments of the present invention include intuitive and powerful tools (e.g., graphical, audio, video, and tutorial guides), which may focus on each phonetic sound of a word to enable a user to pinpoint a proper pronunciation of each word. More specifically, exemplary embodiments may enable a system user to receive substantially instant visual analysis of spoken sounds (i.e., phonemes), words, or sentences. Moreover, exemplary embodiments may identify and provide a user with “problem areas” within a word, sentence, or both, as well as live examples, step-by-step instructions, and animations, which may assist in improvement. Accordingly, the user may pinpoint pronunciation problems, and correct and improve via one or more tools, as described more fully below.

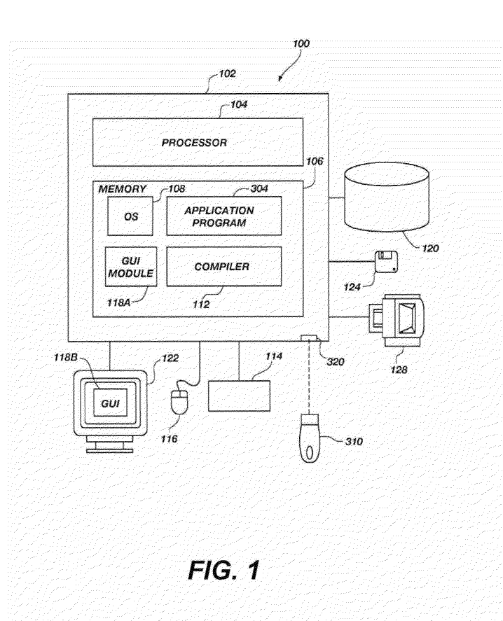

FIG. 1 illustrates a computer system 100 that may be used to implement embodiments of the present invention. Computer system 100 may include a computer 102 that comprises a processor 104 and a memory 106, such as random access memory (RAM) 106. For example only, and not by way of limitation, computer 102 may comprise a workstation, a laptop, or a hand held device such as a cell phone or a personal digital assistant (PDA), or any other processor-based device known in the art. Computer 102 may be operably coupled to a display 122, which presents images, such as windows, to the user on a graphical user interface 118 B. Computer 102 may be operably coupled to, or may include, other devices, such as a keyboard 114, a mouse 116, a printer 128, speakers 119, etc.

Generally, computer 102 may operate under control of an operating system 108 stored in the memory 106, and interface with a user to accept inputs and commands and to present outputs through a graphical user interface (GUI) module 118 A. Although the GUI module 118 A is depicted as a separate module, the instructions performing the GUI functions may be resident or distributed in the operating system 108, an application program 130, or implemented with special purpose memory and processors. Computer 102 may also implement a compiler 112 which allows an application program 130 written in a programming language to be translated into processor 104 readable code. After completion, application program 130 may access and manipulate data stored in the memory 106 of the computer 102 using the relationships and logic that are generated using the compiler 112. Computer 102 may also comprise an audio input device 121, which may comprise any known and suitable audio input device (e.g., microphone).

In one embodiment, instructions implementing the operating system 108, application program 130, and compiler 112 may be tangibly embodied in a computer-readable medium, e.g., data storage device 120, which may include one or more fixed or removable data storage devices, such as a zip drive, floppy disc drive 124, hard drive, CD-ROM drive, tape drive, flash memory device, etc. Further, the operating system 108 and the application program 130 may include instructions which, when read and executed by the computer 102, may cause the computer 102 to perform the steps necessary to implement and/or use embodiments of the present invention. Application program 130 and/or operating instructions may also be tangibly embodied in memory 106 and/or data communications devices, thereby making a computer program product or article of manufacture according to an embodiment the invention. As such, the term “application program” as used herein is intended to encompass a computer program accessible from any computer readable device or media. Furthermore, portions of the application program may be distributed such that some of the application program may be included on a computer readable media within the computer and some of the application program may be included in a remote computer.

Those skilled in the art will recognize that many modifications may be made to this configuration without departing from the scope of the present invention. For example, those skilled in the art will recognize that any combination of the above components, or any number of different components, peripherals, and other devices, may be used with the present invention.

As described more fully below, exemplary embodiments of the present invention may include, or be associated with, real-time speech recognition, which may also be referred to as voice recognition. By way of example only, systems and methods, which may be employed in the systems and methods of the present invention, are disclosed in U.S. Pat. No. 5,640,490 (“the '490 patent”), which issued to Hansen et al. on Jun. 17, 1997, the disclosure of which is hereby incorporated by reference in its entirety. As described in the '490 patent, speech recognition may comprise breaking an uttered word or a sentence into individual phonemes or sounds. Therefore, in accordance with one or more exemplary embodiments described herein, audio input data may be analyzed to evaluate a user's pronunciation.

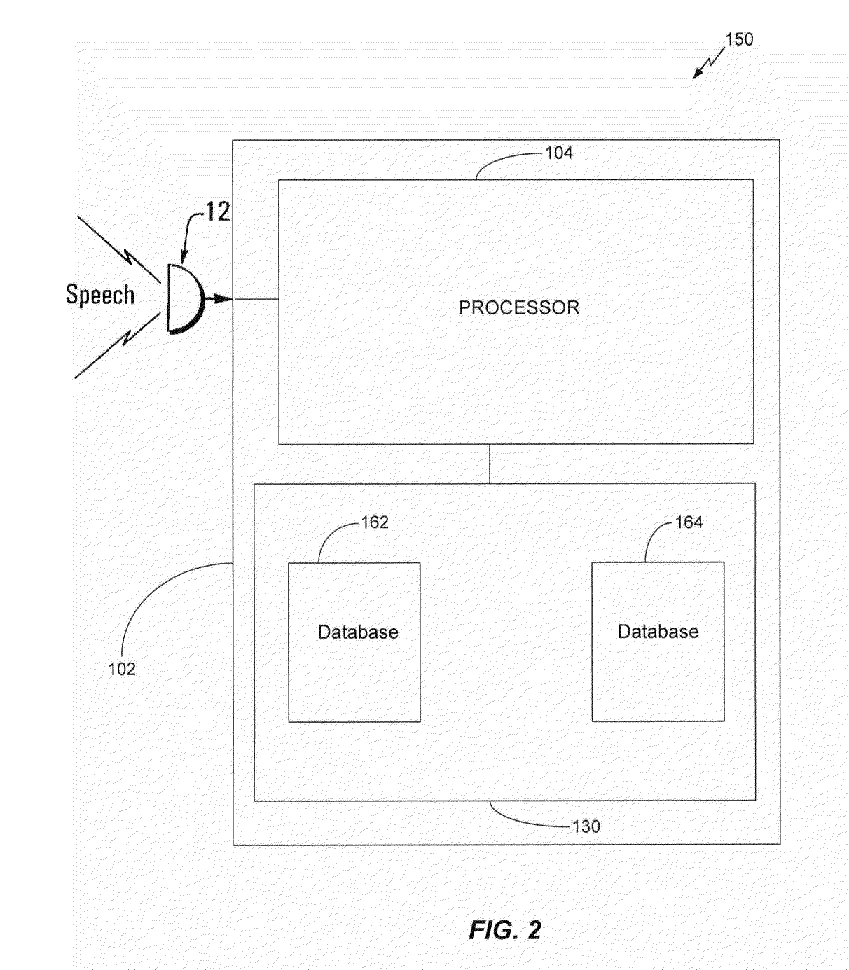

FIG. 2 illustrates a system 150 according to an exemplary embodiment of the present invention. According to one exemplary embodiment, system 150 is configured for receiving an audio speech signal and for converting that signal into a representative audio electrical signal. In an exemplary embodiment, system 150 comprises an input device 160 for inputting an audio signal and converting it to an electrical signal. Input device 160 may comprise, for example only, a microphone.

In addition to input device 160, system 150 may comprise processor 104, which may comprise, for example only, audio processing circuitry and sound recognition circuitry. Processor 104 receives the audio electrical signal generated by input device 160, and then functions so as to condition the signal so that it is in a suitable electrical condition for digital sampling. Further, processor 104 may be configured to analyze a digitized version of the audio signal in a manner to extract various acoustical characteristics from the signal. Processor 104 may be configured to identify specific phoneme sound types contained within the audio speech signal Importantly, this phoneme identification is done without reference to the speech characteristics of the individual speaker, and is done in a manner such that the phoneme identification occurs in real time, thereby allowing the speaker to speak at a normal rate of conversation. Once processor 104 has extracted the corresponding phoneme sounds, processor 104 may compare each spoken phoneme to a dictionary pronunciation stored within a database 162 and grade a pronunciation of the spoken phoneme according to a resemblance between the spoken phoneme and a phoneme in database 162. It is noted that database 162 may be built on standard international phonetic rules and dictionaries. System 150 may also include one or more databases 164, which may comprise various audio and video files associated with known phonemes, as will be described more fully below.

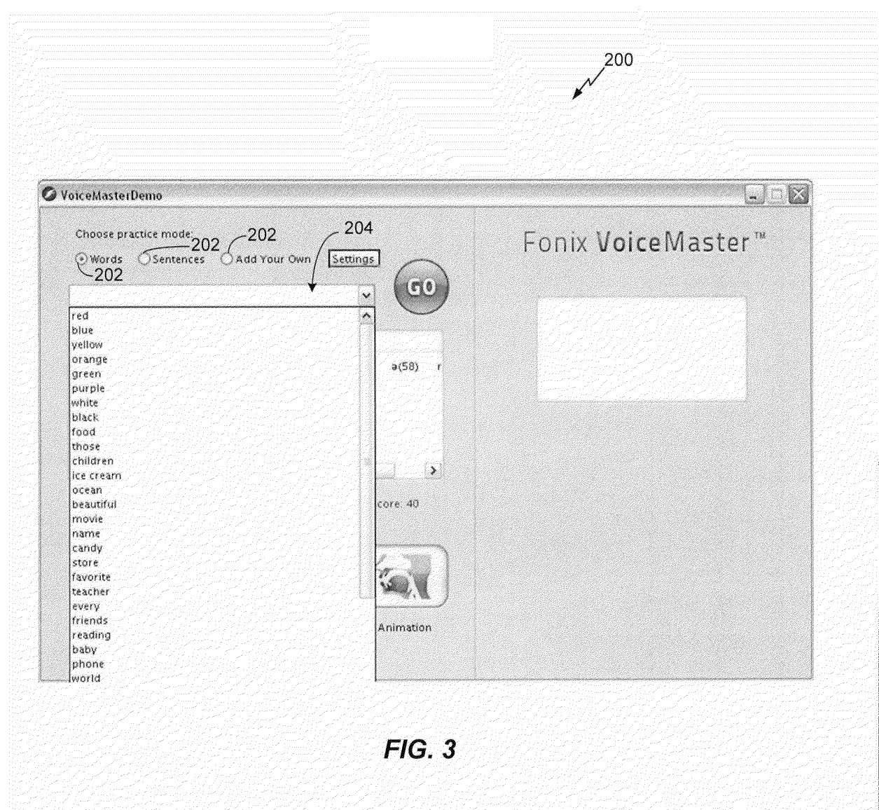

With reference to FIGS. 1, 2, and the screenshots illustrated in FIGS. 3-22, various exemplary embodiments of the present invention will now be described. It is noted that the screenshots of the interfaces illustrated in FIGS. 3-19 are only example interfaces and are not to limit the exemplary embodiments described herein. Accordingly, the functionality of the described embodiments may be implemented with the illustrated interfaces or one or more other interfaces. FIG. 3 is a screenshot of a page 200, according to an exemplary embodiment of the present invention. As illustrated, page 200 may include a plurality of selection buttons 202 for enabling a user to select a desired practice mode (i.e., either a “Words” practice mode, a “Sentences” practice mode, or an “Add Your Own” practice mode).

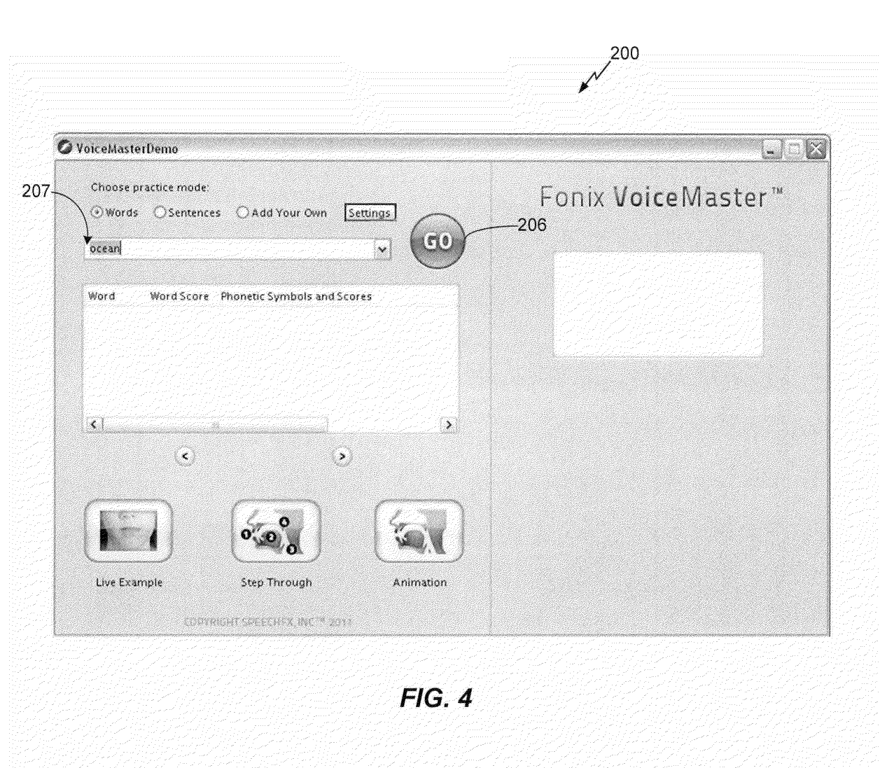

Upon selection of the “Words” practice mode, a drop-down menu 204 may provide a user with a list of available words. As illustrated in FIG. 4, the word “ocean” has been selected via drop-down menu 204 and exists within text box 207. After a word (e.g., “ocean”) has been selected, a user may “click” a button 206 (“GO” button) and, thereafter, the user may verbalize the word. Upon receipt of the audible input at computer 102, application program 130 may provide a user with feedback on his or her pronunciation of the word. It is noted that application program 130 may be speaker-independent and, thus, may allow for varying accents.

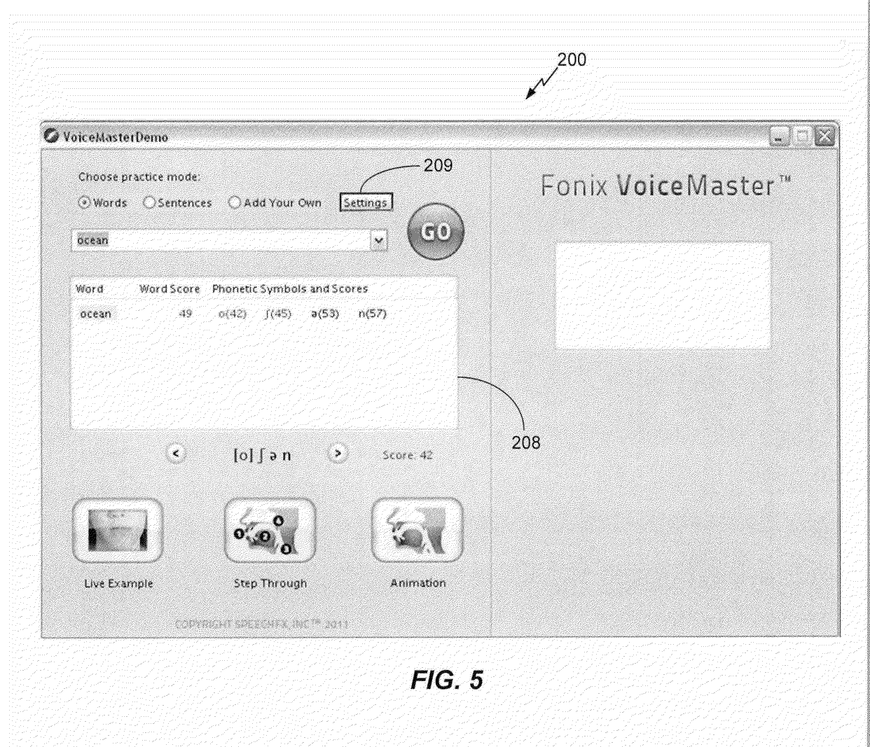

More specifically, with reference to FIG. 5, after a user has spoken a selected word, application program 130 may display, within a window 208, a total score for the user's pronunciation of the word, as well as scores for each phoneme of the word. As illustrated in FIG. 5, application program 130 has given a score of “49” for the word “ocean.” Further, the word is divided up into individual phonemes, and a separate score for each phoneme is provided. As illustrated, application program 130 has given a score of “42” for the first phoneme of the word, a score of “45” for the second phoneme of the word, a score of “53” for the third phoneme of the word, and a score of “57” for the fourth phoneme of the word.

According to one exemplary embodiment of the present invention, application program 130 may display words, phonemes, or both, in one color (e.g. red) to indicate an improper pronunciation and another color (e.g., black) to indicate proper pronunciation. It is noted that scores associated with the words or phonemes may also be displayed in a color, which is indicative of improper or proper pronunciation.

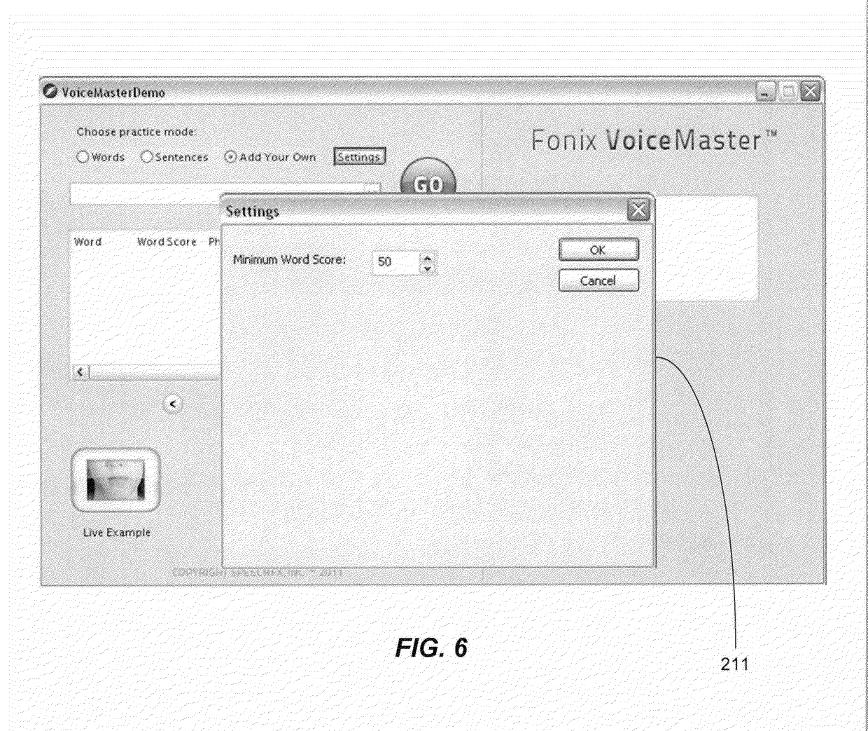

Further, differentiating between “proper” and “improper” pronunciation may depend on a threshold level. For example, a score greater than or equal to “50” may indicate a proper pronunciation while a score below “50” may indicate an improper pronunciation. Moreover, exemplary embodiments may provide for an ability to change a threshold level which, as described above, may be used to judge whether the pronunciation is acceptable or not. An adjustable threshold level may enable a user to set his own evaluation threshold to be treated as a beginner, intermediate, or as an advanced user. For example, with reference to FIG. 5, page 200 may include a “Settings” button 209, which, upon selection, generates a window 211 (see FIG. 6) that is configured to enable a user to enter a desired threshold level (e.g., 1-99) for differentiating between “proper” and “improper” pronunciation.

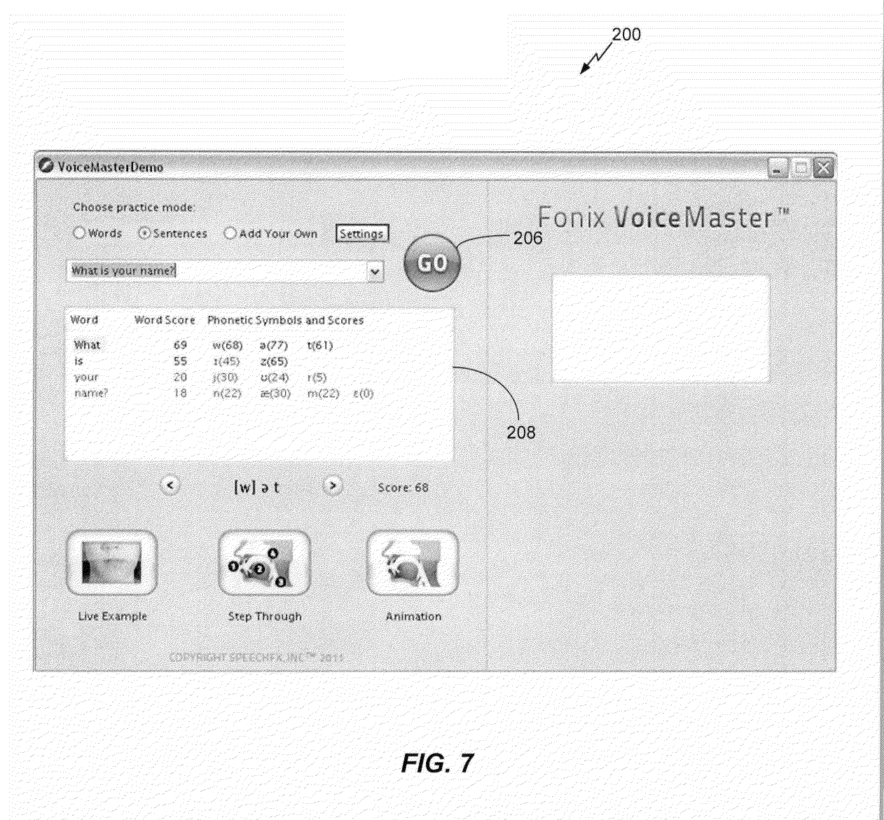

Upon selection of the “Sentences” practice mode, drop down menu 204 may provide a user with a list of available sentences. As illustrated in FIG. 7, the sentence “What is your name?” has been selected via the drop down menu. After a sentence (e.g., “What is your name?”) has been selected, a user may “click” button 206 (“GO” button) and, thereafter, the user may verbalize the sentence. Upon receipt of the audible input, application program 130 may provide a user with feedback on his or her pronunciation of each phoneme and each word in the sentence. More specifically, application program 130 may display pronunciation scores for each phoneme in the selected sentence.

As illustrated in FIG. 7, application program 130 has given a score of “69” for the word “What.” Further, the word is divided up into separate phonemes, and a separate score for each phoneme is provided, similarly to the word “ocean,” as described above. As illustrated, application program 130 has given a score of “55” for the word “is,” a score of “20” for the word “your,” and a score of “18” for the word “name.”

As noted above, application program 130 may display one or more of scores, words, and phonemes in one color (e.g., red) to indicate an improper pronunciation and another color (e.g., black) to indicate proper pronunciation. Accordingly, in an example wherein a threshold level is set to “50,” the word “What” as well as the associated phoneme and scores would be in a first color (e.g., black). Further, the word “is” and its second phoneme and associated score (i.e., 65) would be in the first color and its first phoneme and associated score (i.e., 45) would be in a second color (e.g., red). Further, each of the words “your” and “name” as well as each phoneme and the associated scores for each of words “your” and “name,” would be in the second color (e.g., red).

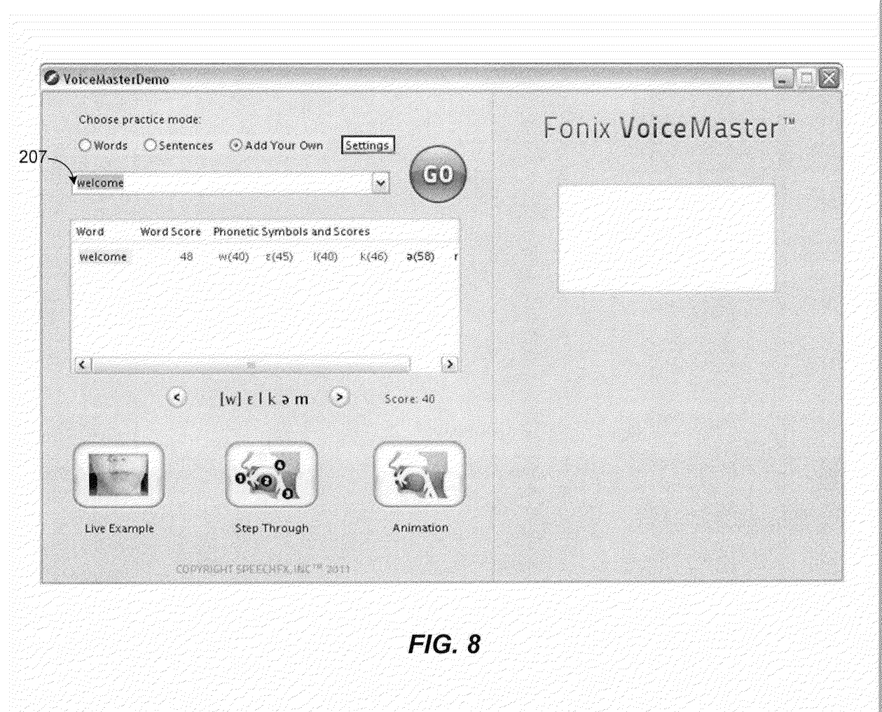

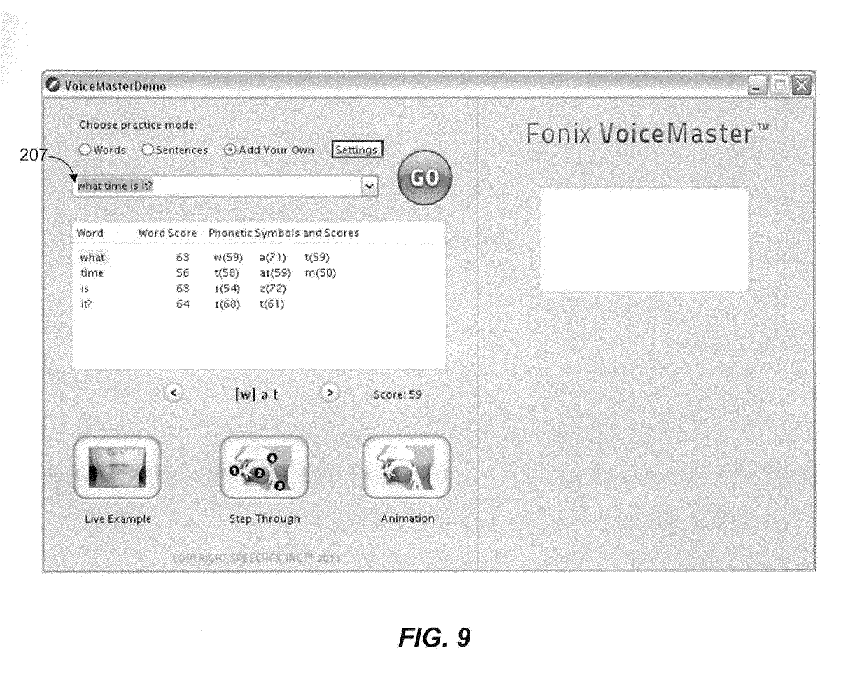

Upon selection of the “Add Your Own” practice mode, a user may enter either any word or any sentence including a plurality of words into text box 207. After a word (e.g., “welcome” as shown in FIG. 8) or a sentence (e.g., “What time is it?” as shown in FIG. 9) has been entered, a user may “click” button 206 (“GO” button) and, thereafter, the user may verbalize the entered word or sentence. Upon receipt of the audible input, application program 130 may provide a user with feedback on his or her pronunciation of the chosen word, or each word in the chosen sentence. More specifically, application program 130 may display pronunciation scores for each phoneme in the selected word or the selected sentence.

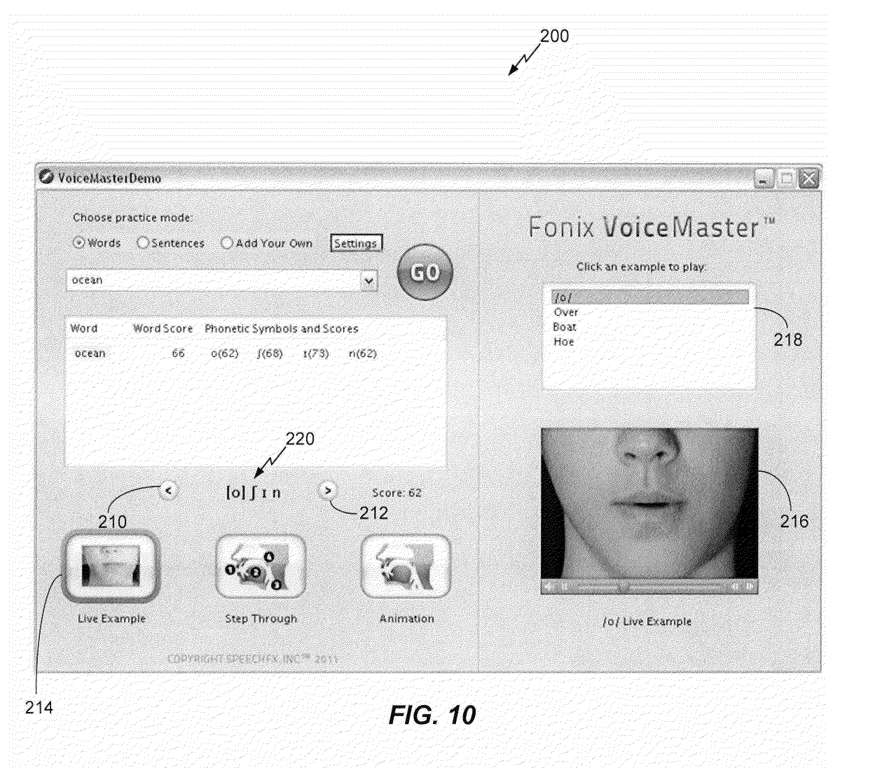

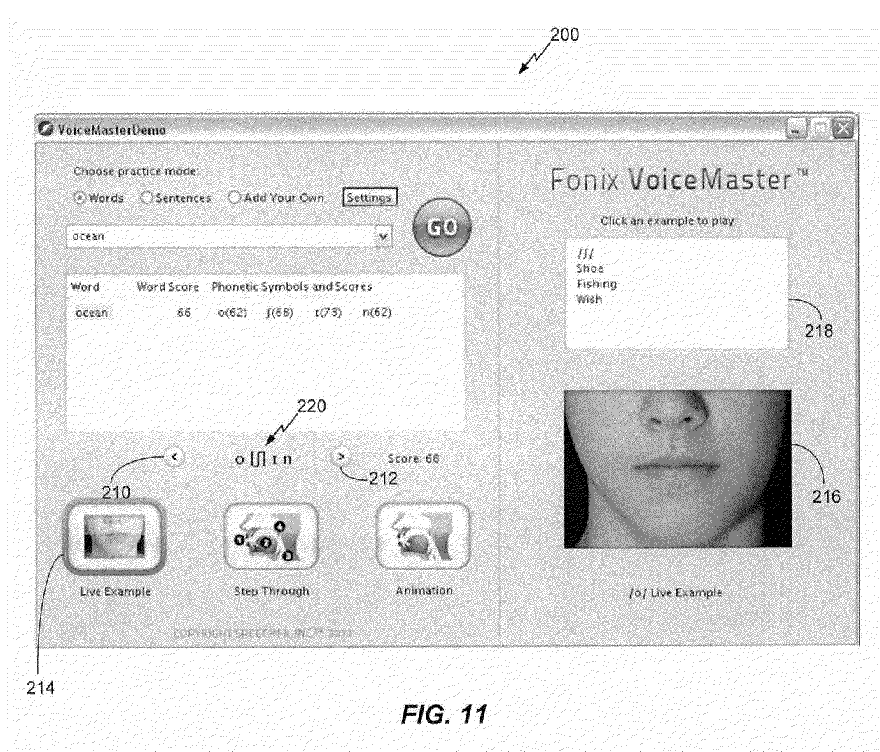

According to another exemplary embodiment, application program 130 may enable a user to select a phoneme of the word and view a video recording of a real-life person verbalizing the phoneme or a word that includes that phoneme. For example, with reference to FIG. 10, a user may select, via selection button 210 or 212, a phoneme of the selected word. The user may then “click on” a “Live Example” tab 214, which may cause a video of a person to appear in a window 216. It is noted that the video displayed in window 216 may be accessed via database 164 (see FIG. 2). The user may select, via a window 218, the phoneme by itself (i.e., in this example “/o/”) or a word that includes that phoneme (e.g., “Over,” “Boat,” or “Hoe”). Upon selection of a phoneme or a word including the phoneme, an associated video recording, which may visually and audibly illustrate a person verbalizing the selected phoneme, may be played in window 216. It is noted that in FIG. 10, the first phoneme of the word “ocean” is selected, as indicated by reference numeral 220, and in FIG. 11, the second phoneme of the word “ocean” is selected, as indicated by reference numeral 220.

In accordance with another exemplary embodiment, application program 130 may provide a user with step-by-step instructions on how to properly form the lips, teeth, tongue, and other areas in the mouth in order to correctly pronounce the target phoneme being practiced. More specifically, in a multi-step guide, graphics may be provided to show a cut-out, side view of a face, wherein each step is highlighted with a box around the area for each particular mouth movement. Audio may also be provided with the graphics. Further, a short explanation of each step may also be included adjacent the graphics. This may enable a user to confirm the positioning of his or her lips, tongue, teeth, other areas of the mouth, or any combination thereof.

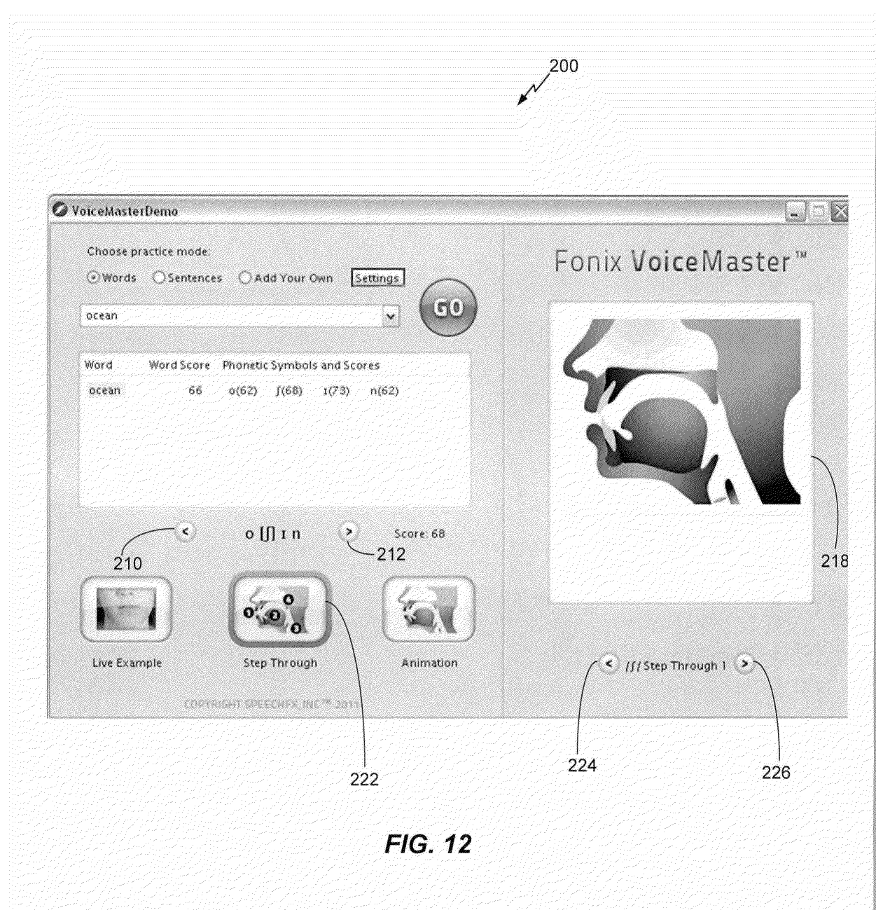

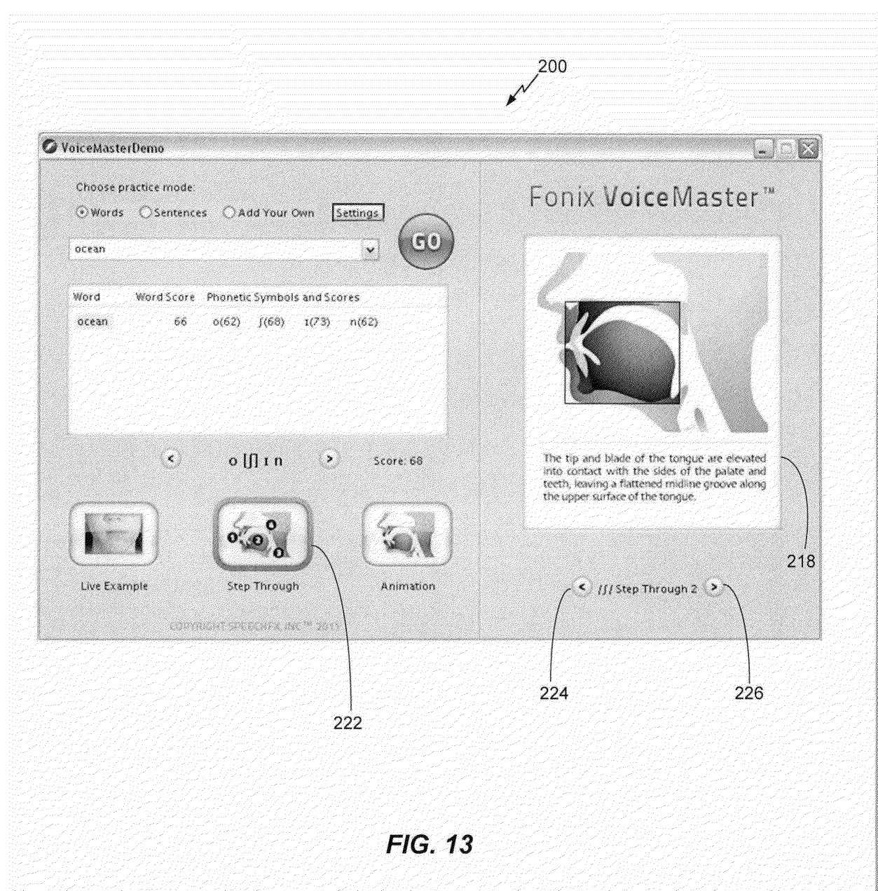

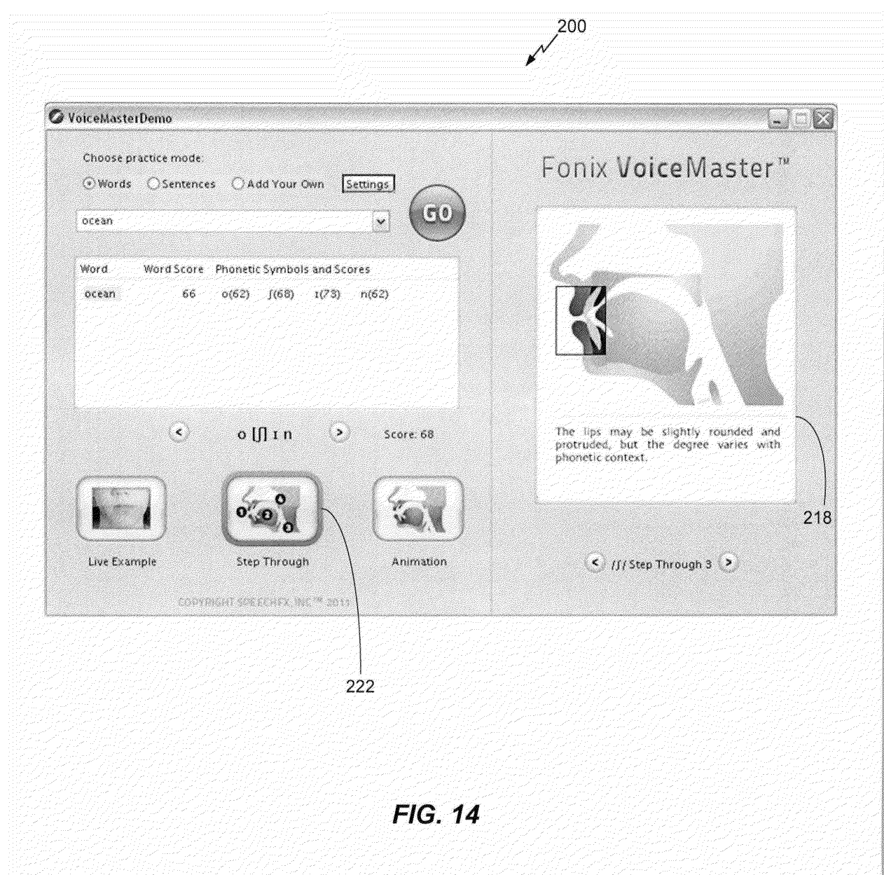

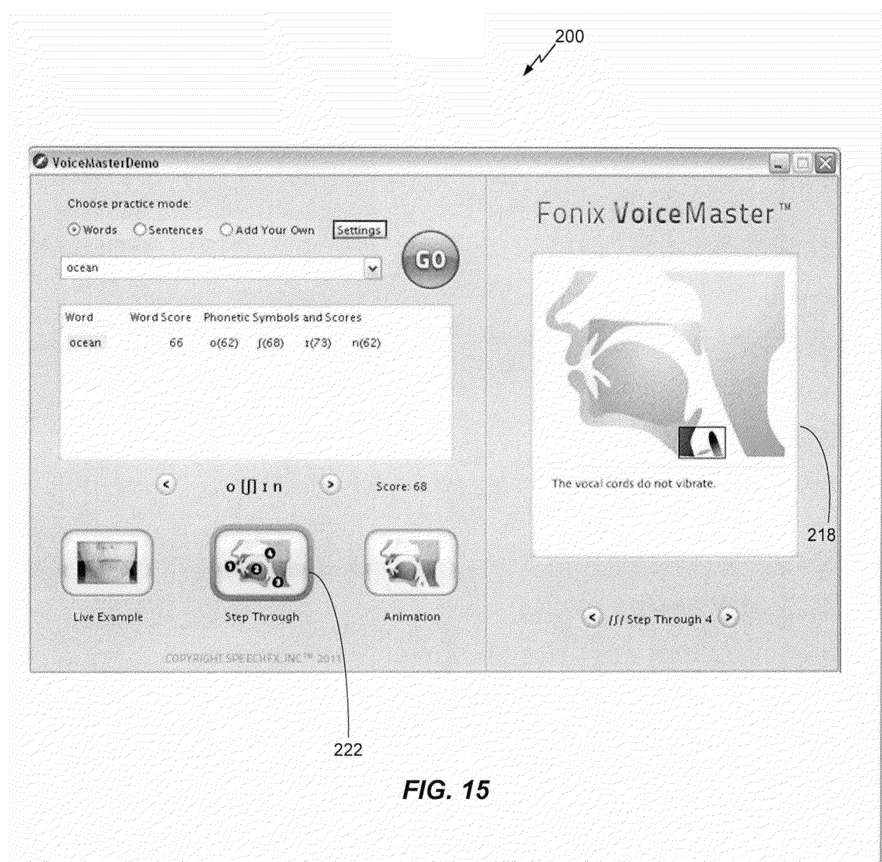

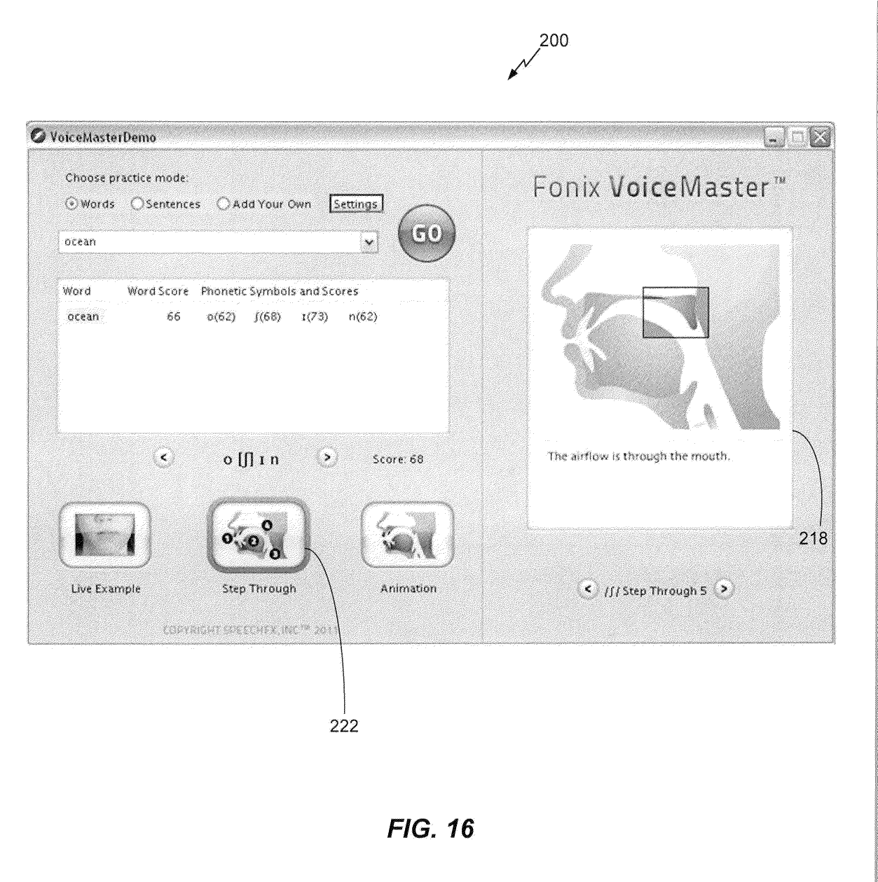

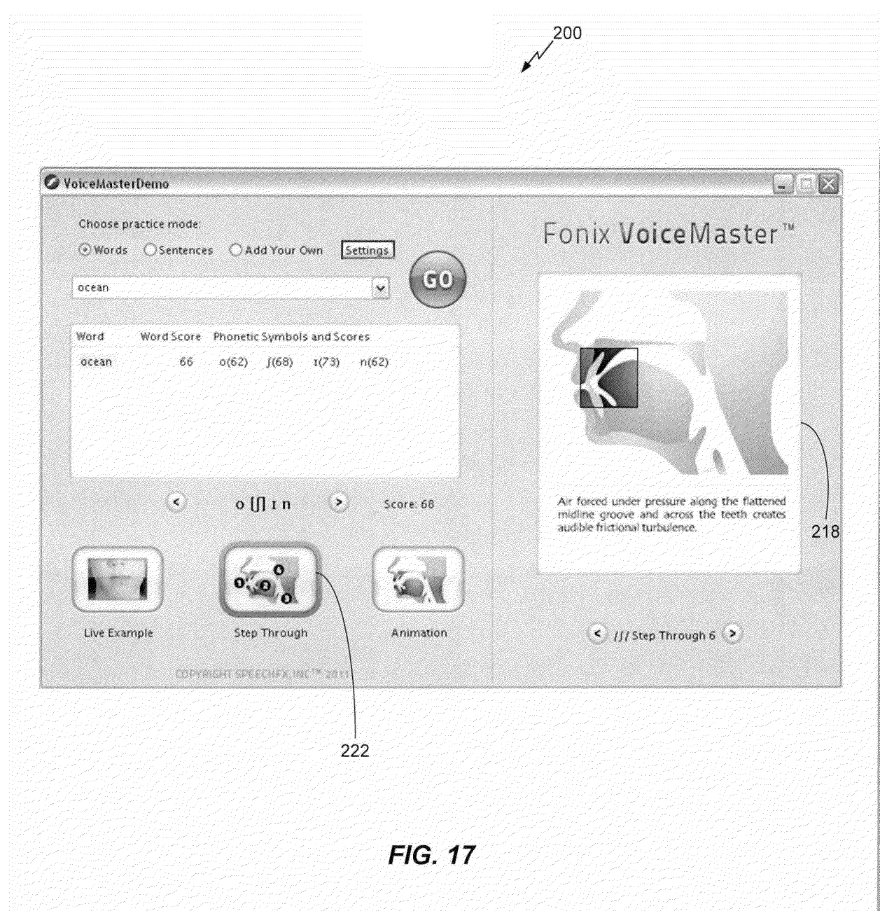

For example, with reference to FIG. 12, a user may select, via selection button 210 or 212, a phoneme of a selected word. The user may then “click on” a “Step Through” tab 222, which may cause a graphical, cut-out, side view of a person's head to appear in window 218. It is noted that the file displayed in window 218 may be accessed via database 164 (see FIG. 2). With a specific phoneme selected (i.e., via selection button 210 or 212), a user may navigate through a set of instructions via selection arrows 224 and 226. It is noted that FIGS. 12-17 illustrate the second phoneme of the word “ocean” being selected, wherein FIG. 13 illustrates a first set of instructions, FIG. 14 illustrates a second set of instructions, FIG. 15 illustrates a third set of instructions, FIG. 16 illustrates a fourth set of instructions, and FIG. 17 illustrates a fifth set of instructions.

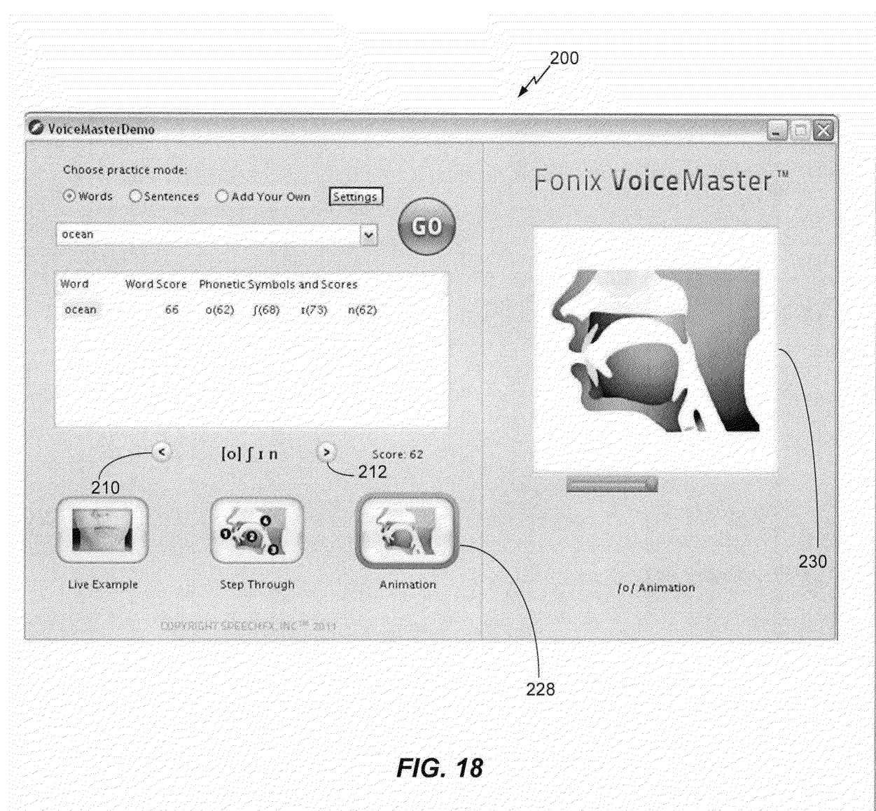

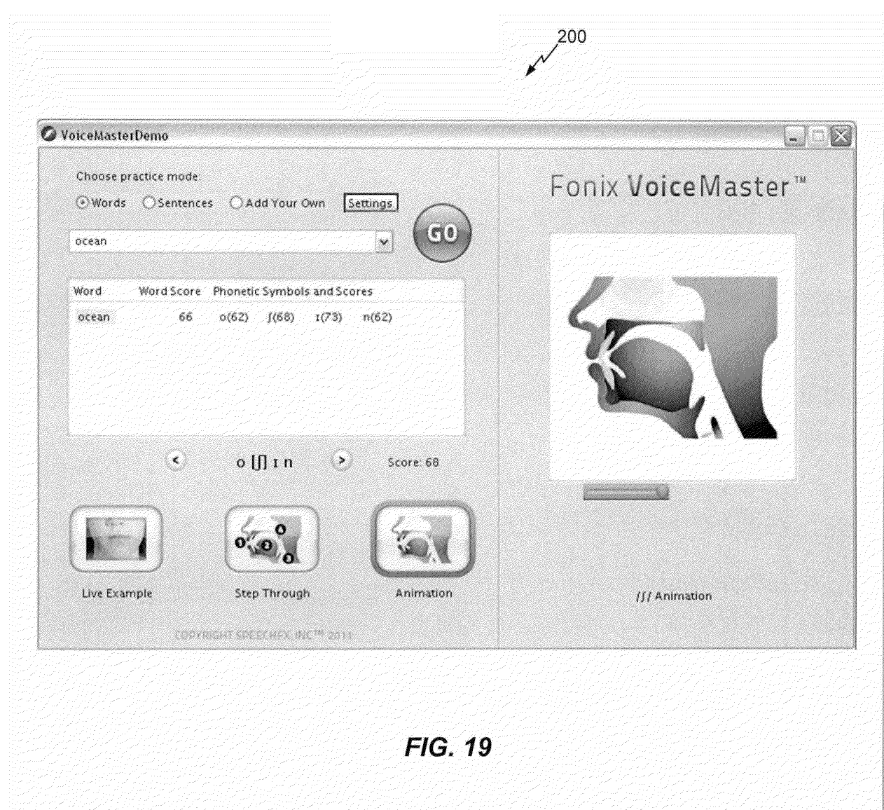

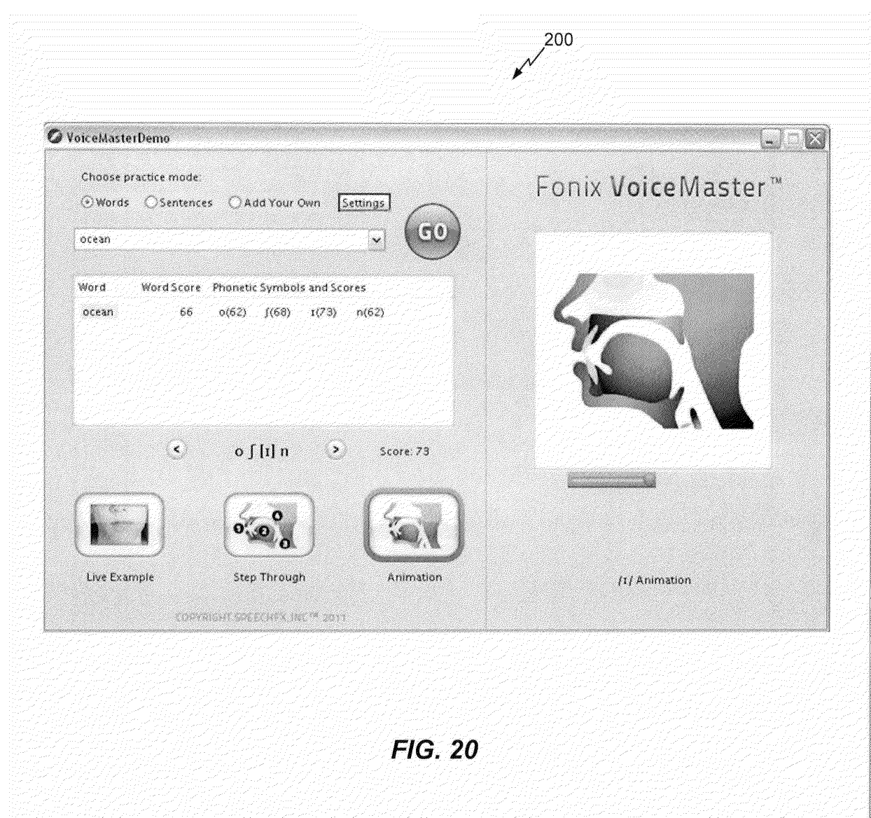

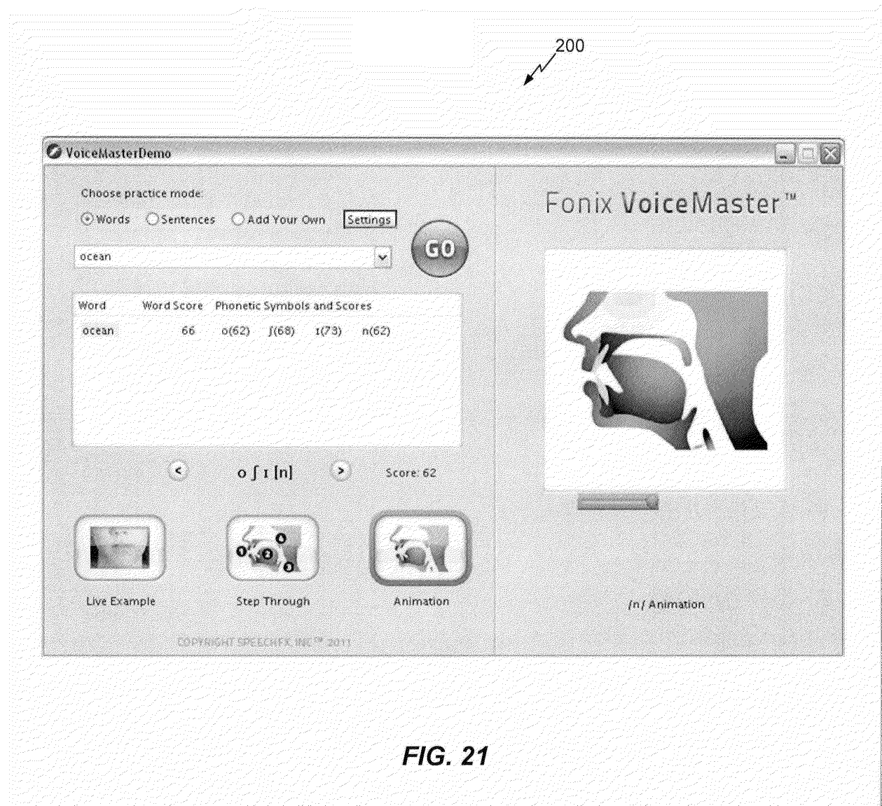

According to another exemplary embodiment, application program 130 may combine each step in the multi-step guide, as described above, to generate an animated movie clip. The move clip may allow a user to visualize positions and movements of various parts of a face as a target phoneme is being pronounced. For example, with reference to FIG. 18, a user may select, via selection button 210 or 212, a phoneme of a selected word. The user may then “click on” an “Animation” tab 228, which may cause an animated movie clip of a graphical, cut-out, side view of a person's head to appear in a window 230. The animation, which may include audio, may illustrate positions and movements of various parts of a face as a target phoneme is being pronounced. It is noted that the video displayed in window 230 may be accessed via database 164 (see FIG. 2). Further, it is noted that FIGS. 18-21 illustrate the animation functionality with respect to the word “ocean,” wherein FIG. 18 illustrates the first phoneme of the word “ocean” being selected, FIG. 19 illustrates the second phoneme of the word “ocean” being selected, FIG. 20 illustrates the third phoneme of the word “ocean” being selected, and FIG. 21 illustrates the fourth phoneme of the word “ocean” being selected.

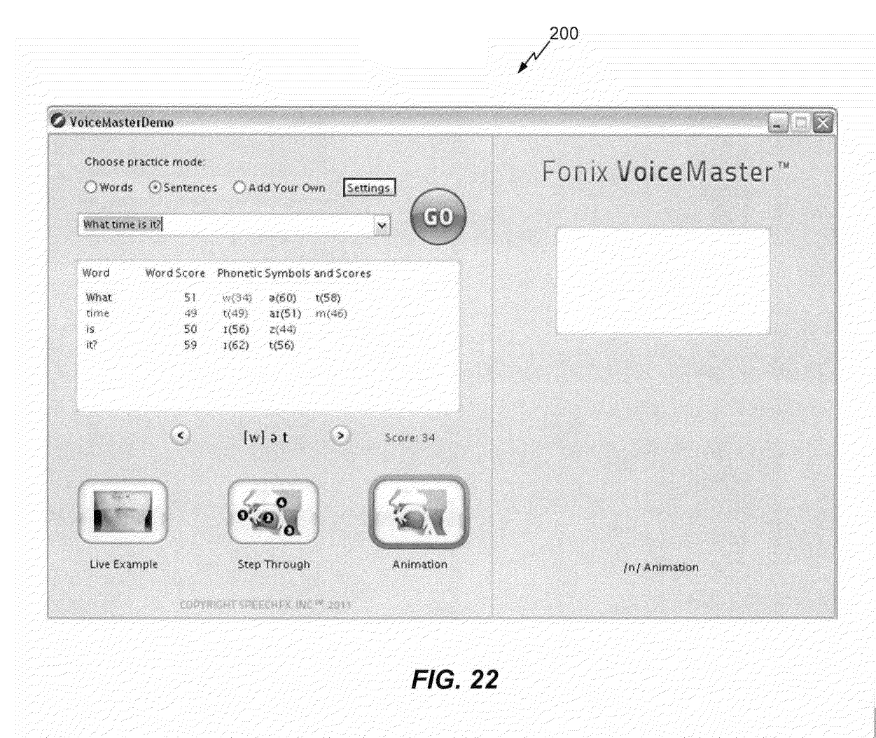

It is noted that the exemplary embodiments described above concerning the multi-step guide and the animation functionality may also be applied to user-entered words, sentences chosen via drop-down menu 204, and user-entered sentences. For example, with reference to FIG. 22, application program 130 may provide a multi-step guide for each phoneme of each word of the selected sentence “What time is it?” Application program 130 may also provide a live example or an animation for each phoneme of each word of a sentence, either user-entered or selected via the drop down menu 204.

As described herein, exemplary embodiments of the present invention may provide a user with detailed information for each phoneme contained in a spoken word as well as every phoneme for every spoken word in a sentence. This information may include feedback (e.g., scoring of words and phonemes), live examples, step-by-step instructions, and animation. It is noted that each of the live example, step-by-step instructions, or animation functionality, as described above, may be referred to as “graphical output.” With the provided information, users can focus not only on the word(s) that need more practice, but also on each single phoneme within a word to better improve his or her pronunciation.

Although the exemplary embodiments of the present invention are described with reference to the English language, the present invention is not so limited. Rather, exemplary embodiments may be configured to support any known and suitable language such as, for example only, Castilian Spanish, Latin American Spanish, Italian, Japanese, Korean, Mandarin Chinese, German, European French, Canadian French, UK English and others. It is noted that the exemplary embodiments of the present invention may support standard BNF grammars. Further, for Asian languages, Unicode wide characters for inputting and grammars may be supported. By way of example only, for each supported language, a dictionary, neural networks with various sizes (small, medium, or large) and various sample rates (e.g., 8 KHz, 11 KHz, or 16 KHz) may be provided.

Application program 130 may be utilized (e.g., via software developers) as a software developers kit (SDK) as a tool to develop a language learning application. Further, since access to the functionality described herein may be through an application programming interface (API), application program 130 may be easily implemented into other language learning software, tools, online study manuals and other current language learning curriculum.

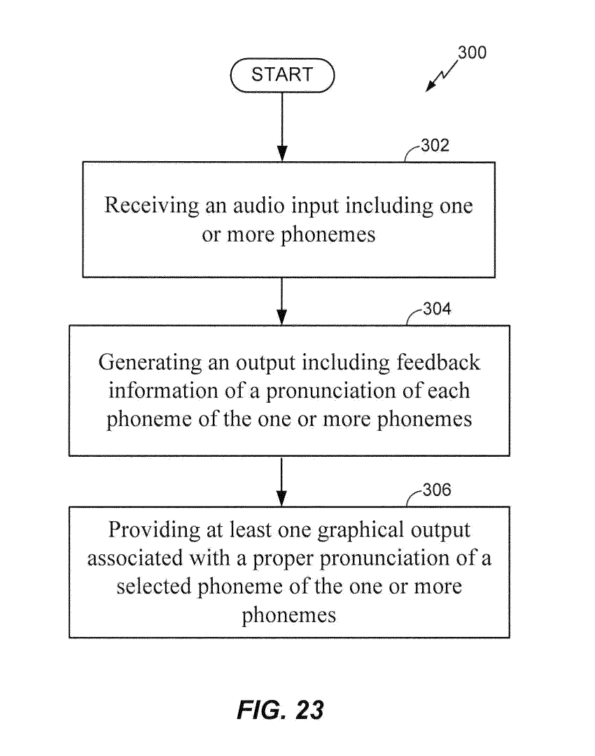

FIG. 23 is a flowchart illustrating another method 300, in accordance with one or more exemplary embodiments. Method 300 may include receiving an audio input including one or more phonemes (depicted by numeral 302). Further, method 300 may include generating an output including feedback information of a pronunciation of each phoneme of the one or more phonemes (depicted by numeral 304). Method 300 may also include providing at least one graphical output associated with a proper pronunciation of a selected phoneme of the one or more phonemes (depicted by numeral 306).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A method, comprising:
receiving an audio input including one or more phonemes;
generating an output including feedback information of a pronunciation of each phoneme of the one or more phonemes; and
providing at least one graphical output associated with a proper pronunciation of a selected phoneme of the one or more phonemes.

2. The method of claim 1, the receiving an audio input comprising receiving a sentence including a plurality of words, each word including at least one phoneme of the one or more phonemes.

3. The method of claim 1, the generating comprising generating a numerical pronunciation score for each of the one or more phonemes.

4. The method of claim 3, the generating a numerical pronunciation score for each of the one or more phonemes comprising displaying each score less than a threshold level in a first color and each score greater than or equal to the threshold level in a second, different color.

5. The method of claim 1, the providing at least one graphical output comprising at least one of:
displaying a video recording of the selected phoneme being pronounced;
displaying a multi-step guide for correctly pronouncing the selected phoneme; and
displaying an animated video of the selected phoneme being pronounced.

6. The method of claim 5, the displaying a multi-step guide comprising displaying an animated, cut-out, side view of a face including step-by-step instructions for proper pronunciation of the selected phoneme.

7. The method of claim 5, the displaying an animated video comprising displaying an animated, cut-out, side view of a face.

8. The method of claim 1, the receiving an audio input comprising receiving the audio input including at least one word selected from a list of available words.

9. The method of claim 1, the receiving an audio input comprising receiving the audio input including at least one word provided by a user.

10. A system, comprising:
at least one computer; and
at least one application program stored on the at least one computer and configured to:
receive an audio input including one or more phonemes;
generate an output including feedback information of a pronunciation of each phoneme of the one or more phonemes; and
provide at least one graphical output associated with a proper pronunciation of a selected phoneme of the one or more phonemes.

11. The method of claim 10, the at least one application program further configured to provide a list of available words for the input.

12. The method of claim 10, at least one application program further configured to provide a list of available sentences for the input.

13. The method of claim 10, at least one application program further configured to display at least one or more of a video recording of the selected phoneme being pronounced, a multi-step guide for correctly pronouncing the selected phoneme, and an animated video of the selected phoneme being pronounced.

14. The method of claim 10, at least one application program configured to operate in either a first mode wherein the input comprises a single word or a second mode wherein the input comprises a sentence including a plurality of words.

15. The method of claim 10, the feedback information comprising a numerical pronunciation score for each of the one or more phonemes.

16. The method of claim 10, the feedback information comprising a numerical pronunciation score for each of the one or more phonemes.

17. The method of claim 10, at least one application program configured to display at least one button for enabling a user to select a phoneme of the one or more phonemes.

18. A computer-readable media storing instructions that when executed by a processor cause the processor to perform instructions, the instructions comprising:
receiving an audio input including one or more phonemes;
generating an output including feedback information of a pronunciation of each phoneme of the one or more phonemes; and
providing at least one graphical output associated with a proper pronunciation of a selected phoneme of the one or more phonemes.

19. The computer readable media of claim 18, the generating comprising generating a numerical pronunciation score for each of the one or more phonemes.

20. The computer readable media of claim 18, the providing at least one graphical output comprising at least one of:
displaying a video recording of the selected phoneme being pronounced;
displaying a multi-step guide for correctly pronouncing the selected phoneme; and
displaying an animated video of the selected phoneme being pronounced.
